(19) United States
(12) Patent Application Publication
(10) Pub. No.: US 2015/0014237 A1
(43) Pub. Date: Jan. 15, 2015

(54) Filter Element, Filter Device and Method

(71) Applicant: MANN+HUMMEL GMBH, Ludwigsburg (DE)

(72) Inventor: Christian Kocksch, Roemerberg (DE)

(21) Appl. No.: 14/311,517

(22) Filed: Jun. 23, 2014

Related U.S. Application Data
(63) Continuation of application No. PCT/EP2012/072576, filed on Nov. 14, 2012.

(30) Foreign Application Priority Data
Dec. 22, 2011 (DE) 10 2011 122 024.4

(51) Int. Cl. F01N 3/08; B29C 65/14; B01D 35/31; B29C 45/14; B01D 29/15; B01D 29/58

(52) U.S. Cl. CPC F01N 3/0871; B01D 29/15; B01D 29/58; B01D 35/31; B29C 45/14795; B29C 65/1412; B29K 2101/00
USPC 210/323.2; 210/497.01; 264/279; 156/272.2

(57) ABSTRACT

A filter element for filtering a fluid, in particular a urea solution, has an end disk provided with an opening. A filter medium is provided that closes off the opening and enables flow of the fluid between a clean side and a raw side of the filter element.

### CROSS-REFERENCE TO RELATED APPLICATIONS

This application is a continuation of international application PCT/EP2012/072576 filed Nov. 14, 2012 designating the United States of America. This application claims the benefit of German patent application DE 10 2011 122 024.4 filed Dec. 22, 2011. The entire contents of the aforesaid international application are incorporated herein by reference.

### TECHNICAL FIELD

The invention concerns a filter element for filtering a fluid, in particular a urea solution. Moreover, the invention concerns a filter device. Furthermore, the invention concerns a method for producing a filter element.

### BACKGROUND

For example, urea solutions are employed in exhaust gas treatment in motor vehicles for reducing the nitrogen oxide emissions. In this context, urea solution is injected by nozzles in the exhaust gas manifold. In particular for avoiding clogging of the nozzles, the urea solution must be filtered.

For example, WO 2010/139706 A1 discloses a filter element for filtering urea solutions. Since such urea solutions freeze at approximately −11° C., the known filter element provides a compensation member of elastically deformable material. The compensation member absorbs a liquid volume increasing upon freezing of the urea solution.

### SUMMARY OF THE INVENTION

An object of the present invention resides in providing an improved filter element, an improved filter device, and an improved method for producing a filter element.

As a solution to this object, a filter element for filtering a fluid, in particular a urea solution, is proposed which comprises an end disk and a filter medium. The end disk has an opening. The filter medium closes off the opening and enables a flow of the fluid between a clean side and a raw side of the filter element.

Since the fluid can flow from the clean side to the raw side and optionally also from the raw side to the clean side, a pressure compensation between the clean side and the raw side is possible. Such a pressure compensation can be required when the fluid freezes and undergoes a volume increase. By means of the pressure compensation, stress within the filter element is avoided so that, for example, an extension of the service life of the filter element can be achieved.

Since the opening is provided in the end disk, the pressure compensation can occur relative to a not yet frozen residual fluid which is arranged adjacent to the opening in particular at the clean side of the filter element. Due to the fact that typically freezing of the fluid occurs from the exterior to the interior and not yet frozen residual fluid therefore generally is located in an area adjoining the end disk at the clean side of the filter element, the present solution is effective at a suitable location in that a pressure compensation is provided through an opening or a filter medium in the end disk.

In comparison to WO 2010/139706 A1, the present invention has in particular the advantage that no compensation element is required on the clean side, even though this is not excluded herein. Such compensation elements can indeed disadvantageously cause contamination at the clean side. This can happen, for example, in that particles detach from the compensation element in operation of the filter element and thereafter can damage, for example, the valves mentioned above.

The fluid is typically a liquid, in particular a urea solution.

The filter medium is, for example, embodied as a synthetic medium. Such a synthetic medium is advantageously not destroyed by ice crystals that are being formed. In particular, the synthetic medium can be embodied as a nonwoven, laid material or woven material. Moreover, the synthetic medium can comprise polypropylene or polyamide. The filter medium is of course fluid-permeable, in particular liquid-permeable. At the same time, the filter element filters contaminants out of the fluid as the latter flows from the raw side to the clean side.

According to one embodiment, on the raw side a compensation element is provided such that, upon freezing of the fluid, the residual fluid flows into a gap between the filter medium and the compensation element. This gap can be already existing or can be formed at the time when the compensation element recedes when the residual fluid flows through the filter element to the raw side. The compensation element comprises preferably an elastomer. The compensation element moreover can be of a closed-pore and/or foamed configuration. The pores may be filled with air. Preferably, the compensation element comprises ethylene propylene diene rubber (also referred to as “EPDM”). The compensation element can have relative to the filter medium a spacing of between 0 and 10 mm, preferably 0 and 5 mm, and more preferred 0 and 2 mm.

According to a further embodiment, the compensation element is embodied as an insulator. Accordingly, the spatial arrangement of the not yet frozen residual fluid in the filter element can be controlled such that the latter collects in an area adjoining the filter element on the clean side. The desired insulating properties of the compensation element can be, for example, provided in that it comprises EPDM. However, also a different closed-pore material is possible whose pores in particular contain air.

According to a further embodiment, the opening in the end disk opens at the clean side inwardly in a support member of the filter element. For example, the support member is a center tube with radial penetrations. The support member can be connected with the filter medium. In particular, the filter medium can be embedded by injection molding in a plastic material wherein, at the same time, the support member is formed.

According to a further embodiment, the support member on the exterior is surrounded by an additional filter medium. The additional filter medium is in particular a filter bellows. The filter bellows can have an annular cross-section which receives in its interior the support member. The additional filter medium forms preferably the main filter medium, i.e., it provides the essential filter work while the filter medium in the opening only ensures the aforementioned pressure compensation. The filter medium and the additional filter medium can have the same degree of separation. The degree of separation can be determined according to “Multipass ISO 19438” wherein in particular it is determined what percentage of which particle size is retained by the filter medium or the additional filter medium.

According to a further embodiment, the end disk is seal-tightly connected radially in outward direction relative to the opening with the additional filter medium. On the clean side of the filter medium, an interior is thus formed which is surrounded by the additional filter medium and is in communication with the opening.

According to a further embodiment, in the opening of the end disk a means is provided which protects the filter medium from mechanical damage. The means can be, for example, in the form of a grid or a cross. The means is preferably designed to prevent manual damage.

Furthermore, a filter device with the filter element according to the invention is proposed.

The filter device can have a housing in which the filter element is received. Moreover, the filter device can have connectors by means of which fluid to be filtered is supplied to the filter element and filtered fluid can be led away from it.

Moreover, a method for producing a filter element is proposed. The method proposes that an opening in an end disk is closed off with a filter medium.

According to one embodiment, the rim area of the filter medium is welded to a rim area of the opening. Welding can be done, for example, by infrared welding or by hot plate welding.

Further possible implementations of the invention encompass also combinations, not explicitly mentioned, of features or embodied examples of the filter element, the filter device or the method described above or in the following with regard to the embodiments. A person of skill in the art will also add or modify individual aspects as improvements of or supplements to the respective basic form of the invention.

Further embodiments of the invention are subject matter of the dependent claims as well as of the embodied examples of the invention disclosed in the following. In the following, the invention will be explained in more detail with the aid of embodied examples with reference to the attached Figures.

### BRIEF DESCRIPTION OF THE DRAWINGS

It is shown in:

FIG. 1: in a section view a filter device according to one embodiment;

FIG. 2: a detail view of FIG. 1;

FIG. 3: in a view from below a filter element of FIG. 1; and

FIG. 4: several method steps for producing a filter element according to one embodiment.

In the Figures same reference numerals indicate same or functionally the same elements inasmuch as nothing to the contrary is indicated.

### DETAILED DESCRIPTION OF THE INVENTION

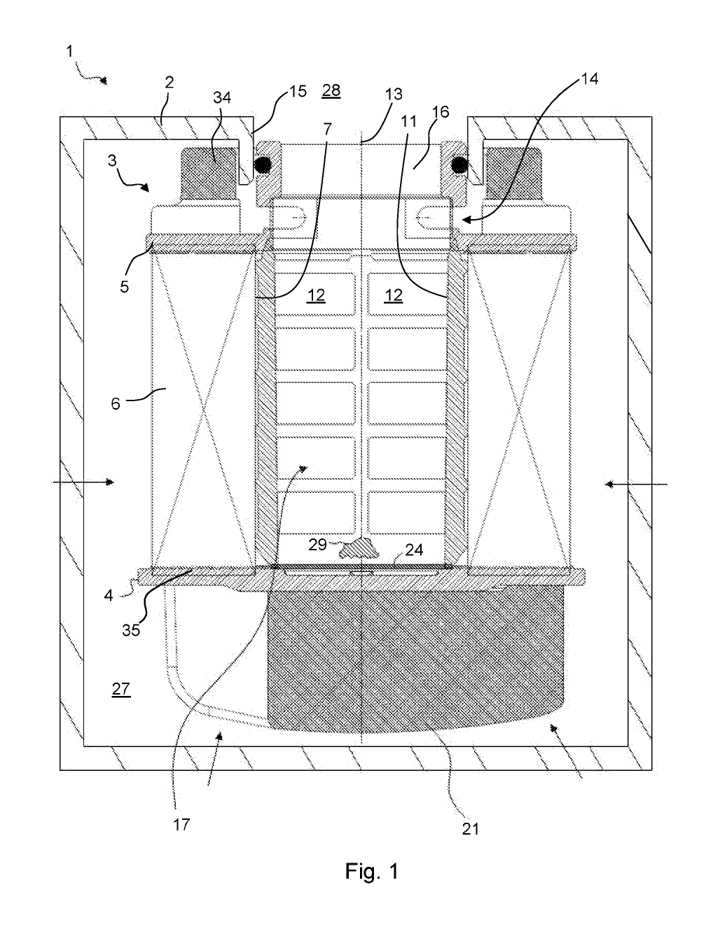

FIG. 1 shows in a section view a filter device 1 according to one embodiment. The filter device 1 can be provided in a motor vehicle, for example. The filter device 1 can be designed to purify a liquid, in particular a urea solution.

The filter device 1 comprises a housing 2 in which a filter element 3 is arranged. The filter element 3 comprises a first end disk 4 and a second end disk 5. Between the two end disks 4, 5, a filter medium in the form of a bellows 6 is arranged. The bellows 6 has in cross-section (perpendicular to the paper plane) an annular cross-section and is welded liquid-tightly at the opposite ends to the end disks 4, 5. In the interior 7 enclosed by the bellows 6, a support member in the form of a central tube 11 is arranged. The central tube 11 has radial penetrations 12 relative to the bellows 6. Radial refers to the center axis 13 of the filter element 3.

An axial collar 14 extends away from the end disk 5 into a connecting opening 15 of the housing 2 and seals at the exterior relative thereto, for example, by means of an O-ring. The filter element 3 is detachably attached in the connecting opening 15 and, as needed, can be exchanged. The collar 14 has an opening 16 which is in liquid flow communication with the interior of the center tube 11. The interior of the center tube 11 is labeled by 17.

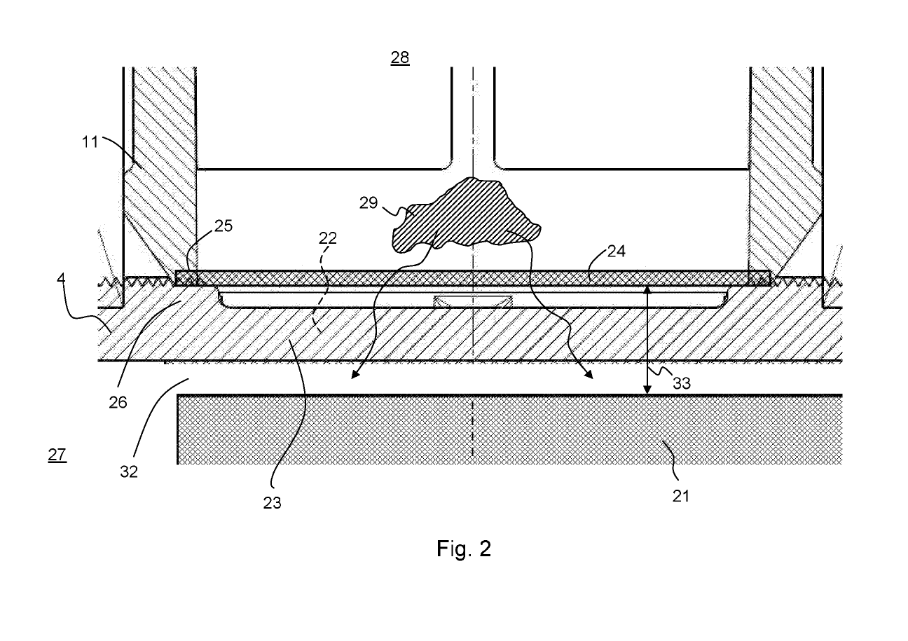

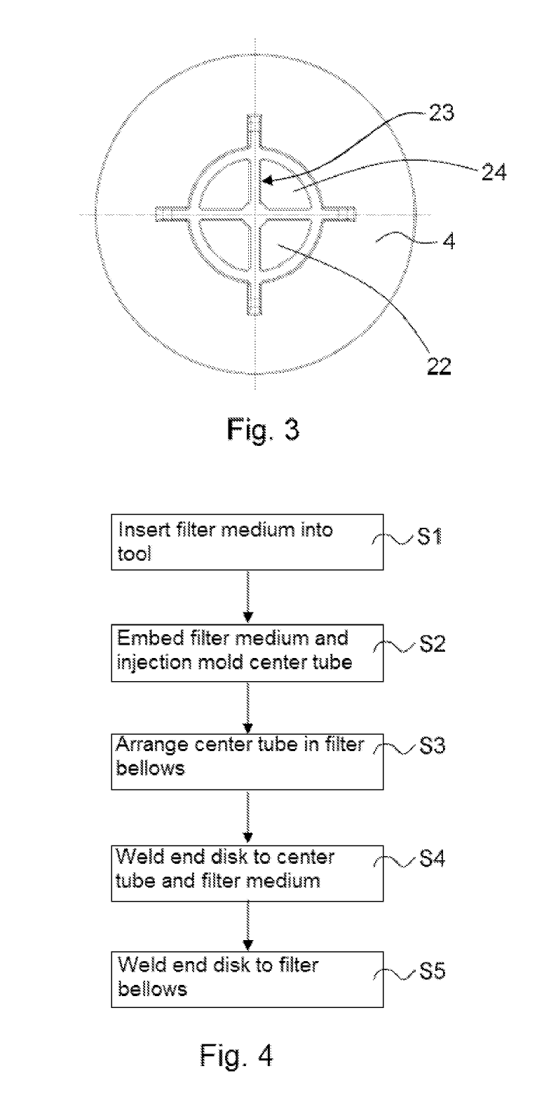

FIG. 2 shows a detail view of FIG. 1. FIG. 3 shows the filter element 3 of FIG. 1 in a view from below wherein a compensation element 21 which will be explained later on in more detail is not illustrated.

The end disk 4 has an opening 22, see FIG. 3. In the opening 22, a cross 24 is arranged which protects a filter medium 24 positioned behind the cross 23 from manual damage. The cross 23 can be embodied monolithic with the end disk 4.

The opening 22, as shown in FIG. 2, is closed off by the filter medium 24. The filter medium 24 according to the embodiment is embodied as a polyamide nonwoven which is liquid-permeable. The filter medium 24 is connected with the center tube 11, for example, by embedding the filter medium 24 by injection-molding. Moreover, the rim area 25 of the filter medium 24 is welded circumferentially to the rim area 26 of the end disk 4 that delimits the opening 22.

The filter medium 24 as well as the bellows 6 divide the filter device 1 into a raw side 27 and a clean side 28. At the raw side 27 liquid to be cleaned is located which in operation of the filter device 1 flows substantially exclusively through the bellows 6 (and not the filter medium 24) and is thereby purified. The liquid reaches thus the clean side 28 and is supplied from there, for example, to an exhaust gas manifold of the motor vehicle.

When the filter device 1 is now exposed, for example, in winter, to very cold conditions, freezing of the liquid may happen. Freezing takes place in the direction indicated by several arrows in FIG. 1 from the exterior to the interior. Since the compensation element 21 is designed as an insulator, a residual liquid identified at 29 in FIG. 1 will freeze last. Pressure generation which accompanies freezing of the residual liquid 29 and which may damage the filter element 3 is avoided in that the residual liquid 29 can flow through the filter medium 24 and the opening 22 into a gap 32 between the end disk 4 and the compensation element 21, as indicated in FIG. 2 by appropriate arrows. In the initial state, i.e., before freezing of the residual liquid 29, the compensation element 21 can rest, for example, directly on the end disk 4, as indicated in FIG. 1. When the residual liquid 29 exits from the opening 22, the compensation element 21 is compressed so that the gap 32 is formed. Also, in another embodiment, the compensation element 21 can already have a gap 32 relative to the end disk 4 in the initial state. The spacing 33 between the filter medium 24 and the compensation element 21 should however be preferably smaller than 10 mm. Otherwise, the insulation property of the compensation element 21 could possibly not be sufficient for achieving that the residual liquid 29 will not freeze at the desired location adjacent to the filter medium 24.

The compensation element 21 as well as the additional compensation element 34 (see FIG. 1) which is arranged between the end disk 5 and the housing 2 can each be comprised of EPDM.

In the following, a method for producing the filter element 3 is explained in connection with FIG. 4.

In a first step S1 of the method, the filter medium 24 is inserted into a tool, not illustrated. In a subsequent step S2, the filter medium 24 is embedded in plastic material by injection molding, wherein at the same time the center tube 11 is produced. Subsequently, in a step S3, the center tube 11 together with the filter medium 24 is arranged in the bellows 6. Initially, the center tube 11 can be arranged together with the filter medium 24 so as to project past the bellows 6. In a step S4, the end disk 4 is heated and is moved in axial direction (axial refers in the present case also to the center axis 13) against the center tube 11 with the filter medium 24 so that the center tube 11 and the filter medium 24 are each welded to the end disk 4. In this context, preferably the rim area 25 of the filter medium 24 is welded to the rim area 26 of the opening 22 in the end disk 4. In this way, the opening 22 in the end disk 4 is closed off by the filter medium 24. At the same time, or shortly thereafter, in step S5 the rim area 35 of the end disk 4 radially outside of the opening 22 is welded to the bellows 6. Welding can be done by hot plate welding.

While specific embodiments of the invention have been shown and described in detail to illustrate the inventive principles, it will be understood that the invention may be embodied otherwise without departing from such principles.

1. A filter element (3) for filtering a urea solution fluid, comprising:
a raw side; and
a clean side, the sides with respect to flow fluid through the filter element;
an end disk (4) having an opening (22) opening into the interior of the filter element;
a filter medium (24) arranged on the end disk and closing off the opening (22), enabling flow of the fluid between the clean side (28) and the raw side (27) of the filter element (3).

2. The filter element according to claim 1, comprising:
a compensation element (21) arrange at the raw side of the filter element,
the compensation element operable such that upon freezing of the fluid,
remaining residual fluid (29) flows into a gap (32) arranged between the filter medium (24) and the compensation element (21).

3. The filter element according to claim 2, wherein,
the compensation element (21) is embodied as an thermal insulator.

4. The filter element according to claim 1, wherein,
the filter element includes a support member (11);
wherein the opening (22) in the end disk (4) at the clean side (28) opens inwardly through the end disk into the support member (11) of the filter element (3).

5. The filter element according to claim 4, wherein,
the support member (11) is circumferentially surrounded on its radial exterior by a second filter medium (6).
the second filter medium (6) including:
a first flow face arranged at a radial exterior of the filter medium;
a second flow face arranged radially inwardly from the first flow face at an interior of the filter element and at the support member;
the the support member (11) is arranged at the second flow face;
wherein the second flow face is arranged at the clean side (28) of the filter element.

6. The filter element according to claim 5, wherein,
the end disk (4) is seal-tightly connected externally relative to the opening (22) with the additional filter medium (6).

7. The filter element according to claim 1, wherein,
a protection means (23) is provided in the opening (22) of the end disk (4),
the protection means protecting the filter medium (24) from mechanical damage.

8. A filter device (1) comprising
a filter element (3) according to claim 1.

9. A method for producing a filter element (3) according to claim 1, comprising:
inserting filter medium (24) into a tool;
embedding the filter medium into plastic material while forming a center tube with the plastic material by injection molding, wherein the center tube is a support member for the filter medium;
arranging the center tube into an interior of the filter element;
closing off an opening (22) in an end disk (4) with the filter medium (24).

10. The method according to claim 9, wherein
welding a rim area (25) of the filter medium (24) onto a rim area (26) of the opening (22).
